(19) United States
(12) Patent Application Publication
(10) Pub. No.: US 2008/0129523 A1
(43) Pub. Date: Jun. 5, 2008

(54) PORTABLE OVERVOLTAGE SENSOR FOR SENSING OVERVOLTAGE OF AN ELECTRICAL DEVICE DURING MANUFACTURING

(76) Inventors: Charles Assimos, Roxboro, NC (US); Jason M. Campbell, Raleigh, NC (US); Michael R. Hawthorne, Huntsville, AL (US); Mohammad H. Tawil, Cary, NC (US)

Correspondence Address: SAWYER LAW GROUP LLP, PO BOX 51418, PALO ALTO, CA, 94303, US

(21) Appl. No.: 11/565,584

(22) Filed: Nov. 30, 2006

(51) Int. Cl. H02H 3/04; H02H 3/20; G08B 21/00

(52) U.S. Cl. 340/662; 361/91.1

(57) ABSTRACT

Methods and systems for sensing overvoltage in an electrical circuit are provided. In one implementation, an overvoltage sensor is provided that includes a first connector operable to be connected to a second connector of a provided electrical circuit, in which the second connector includes a first lead connected to a first voltage in the provided electrical circuit. The overvoltage sensor further includes an indicator circuit coupled to the first connector, in which the indicator circuit is operable to sense overvoltage of the first voltage responsive to the first connector being connected to the second connector.

### FIELD OF THE INVENTION

The present invention relates generally to electrical circuits, and more particularly to techniques for sensing overvoltages in electrical circuits.

### BACKGROUND OF THE INVENTION

Electrical devices are generally designed to operate at a predetermined maximum supply voltage, and damage to the electrical devices can be caused by a voltage that is higher than that for which the devices are rates—which voltage is commonly referred to as “overvoltage”. For example, a wire in an electric light bulb typically carries a current (at a given rated voltage) that is just large enough for the wire to give off light and heat. If the supply voltage to the electric light bulb becomes too large, then the wire may melt and cause the electric light bulb to burn out. Similarly, other electrical devices may stop functioning, or even burst into flames if an overvoltage is supplied to a circuit within such electrical devices.

Overvoltage to an electrical circuit (of an electrical device) can occur during manufacturing of the electrical device. For example, overvoltage of an electrical circuit can be caused by the propagation of electromagnetic disturbances in manufacturing apparatuses, such as guiding structures—e.g., wires, cables, printed circuit board (PCB) traces, and the like. An overvoltage in an electrical circuit that is caused by a manufacturing apparatus is generally difficult to detect, and having a technician follow an electrical device with an oscilloscope throughout various manufacturing processes would be cumbersome.

### BRIEF SUMMARY OF THE INVENTION

In general, in one aspect, this specification describes an overvoltage sensor operable to sense overvoltage in an electrical circuit. The overvoltage sensor includes a first connector operable to be connected to a second connector of a provided electrical circuit, in which the second connector includes a first lead connected to a first voltage in the provided electrical circuit. The overvoltage sensor further includes an indicator circuit coupled to the first connector, in which the indicator circuit is operable to sense overvoltage of the first voltage responsive to the first connector being connected to the second connector.

In general, in another aspect, this specification describes a method for sensing overvoltage in a plurality of electrical circuits in a manufacturing environment using a portable overvoltage sensor. The method includes connecting the portable overvoltage sensor to a connector of a first electrical circuit of the plurality of electrical circuits, and passing the first electrical circuit having the portable overvoltage sensor connected thereto through a manufacturing process, in which the portable overvoltage sensor senses overvoltage of a first voltage in the first electrical circuit during the manufacturing process. The method further includes disconnecting the portable overvoltage sensor from the connector of the first electrical circuit responsive to completion of the manufacturing process.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of an electrical circuit and an overvoltage sensor in accordance with one implementation of the invention.

FIG. 2 illustrates a method for sensing overvoltage in an electrical circuit in accordance with one implementation of the invention.

FIG. 3 is a schematic diagram of an overvoltage sensor in accordance with one implementation of the invention.

FIG. 4 is a block diagram of a device including the electrical circuit of FIG. 1 in accordance with one implementation of the invention.

Like reference symbols in the various drawings indicate like elements.

### DETAILED DESCRIPTION OF THE INVENTION

The present invention relates generally to electrical circuits, and more particularly to techniques for sensing overvoltages in electrical circuits. The following description is presented to enable one of ordinary skill in the art to make and use the invention and is provided in the context of a patent application and its requirements. The present invention is not intended to be limited to the implementations shown but is to be accorded the widest scope consistent with the principles and features described herein.

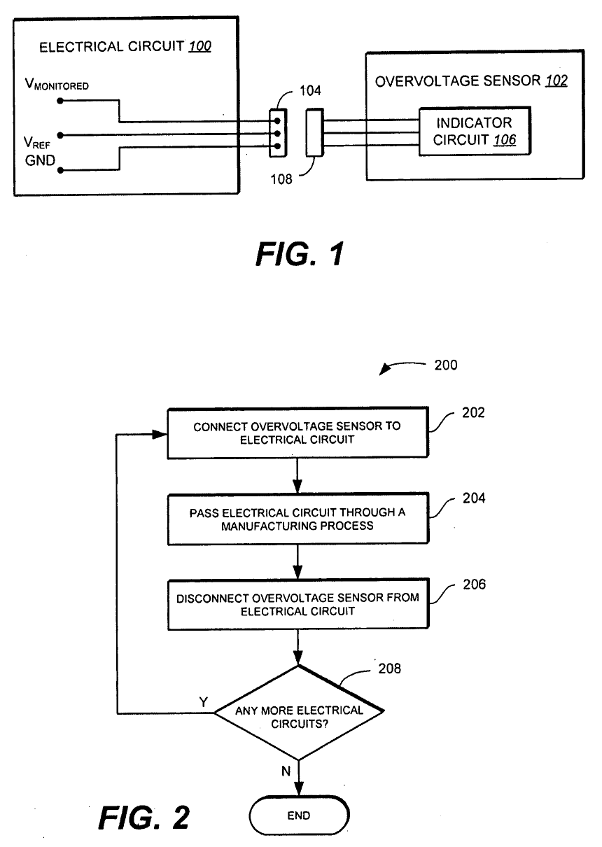

FIG. 1 illustrates an electrical circuit 100 and an overvoltage sensor 102 in accordance with one implementation. In general, the electrical circuit 100 can be any circuit (or circuit board) having a voltage to be monitored (V_{MONITORED}), a reference voltage (V_{REF}), and ground (GND) (or a low power supply). Unlike a conventional electrical circuit that may include a complete overvoltage sensor circuit implemented within the electrical circuit, the electrical circuit 100 includes (in one implementation) only a jumper 104 (or connector) that is connected to a voltage to be monitored (V_{MONITORED}), a reference voltage (V_{REF}), and ground (GND) associated with the electrical circuit 100. In one implementation, the jumper 104 consists of only 3 leads (e.g., pins or sockets), although the jumper 104 can have any number of leads. In one implementation, the jumper 104 is fixedly attached to the electrical circuit 100. In another implementation, the jumper 104 extends from the electrical circuit 102 through a wire having a pre-determined length. In one implementation, the wire is coiled to prevent the wire from interfering with any manufacturing apparatus, or electrical components on the electrical circuit 100.

As shown in FIG. 1, the overvoltage sensor 102 includes an indicator circuit 106 and a connector 108 (that mates to the jumper 104). The connector 108 can be fixedly attached to the overvoltage sensor 102, or extend from the overvoltage sensor 102 through a wire having a pre-determined length. In one implementation, responsive to the overvoltage sensor 102 being connected to the electrical circuit 100, the indicator circuit 106 senses any overvoltages of the voltage (V_{MONITORED}) within the electrical circuit 100. In such an implementation, the indicator circuit 106 can be activated via the reference voltage (V_{REF}), and ground (GND) associated with the electrical circuit 100. Should an overvoltage of the voltage (V_{MONITORED}) occur, the indicator circuit 106 can provide an indication of such overvoltage to a user. In one implementation, the indicator circuit 106 comprises a light-emitting diode (LED) (not shown) that provides a visual indication of an occurrence of an overvoltage. More generally, the indicator circuit 106 can include any type of indicator that provides a perceivable indication (to a user) of an overvoltage—e.g., a visual indication, an audible indication, a tactile indication, or the like. In one implementation, the overvoltage sensor 102 includes a transceiver (not shown) for transmitting a signal (wirelessly) to a computer system responsive to the indicator circuit 106 sensing an overvoltage. The computer can then alert a user of an overvoltage, as well as log a time of the overvoltage and provide a location of the electrical circuit to the user. In one implementation, the overvoltage sensor 102 further includes a process or (not shown) that permits the overvoltage sensor 102 to generate control signals responsive to the indicator circuit 106 sensing an overvoltage of the voltage (V_{MONITORED}). Such control signals can include, for example, sending a control signal (wirelessly) to a manufacturing apparatus to halt operation, or to power down.

FIG. 2 illustrates a method 200 for sensing overvoltage in an electrical circuit (e.g., electrical circuit 100) in accordance with one implementation. An overvoltage sensor (e.g., overvoltage sensor 102) is connected to the electrical circuit (step 202). The overvoltage sensor can be attached to the electrical circuit by a user mating a connector of the overvoltage sensor to a corresponding connector of the electrical circuit. The electrical circuit (including the attached overvoltage sensor) is passed through one or more manufacturing processes (step 204). In general, a manufacturing process includes the application of tools (including manufacturing apparatuses) to the transformation of devices into, e.g., finished goods for sale. A manufacturing process can comprise an intermediate process required for the production and integration of a device's components. For example, additional electrical circuits and/or a device housing can be coupled to the electrical circuit to which the overvoltage sensor is connected during the manufacturing process. Upon completion of the manufacturing process(es), the overvoltage circuit is disconnected from the electrical circuit (step 206). A determination is made (e.g., by the user) whether there are additional electrical circuits (associated with devices to be manufactured) that require the overvoltage sensor (step 208). If there are additional electrical circuits, then the method 200 returns to step 202, in which the overvoltage sensor is attached to another electrical circuit. If, however, there are no additional electrical circuits, then method 200 ends.

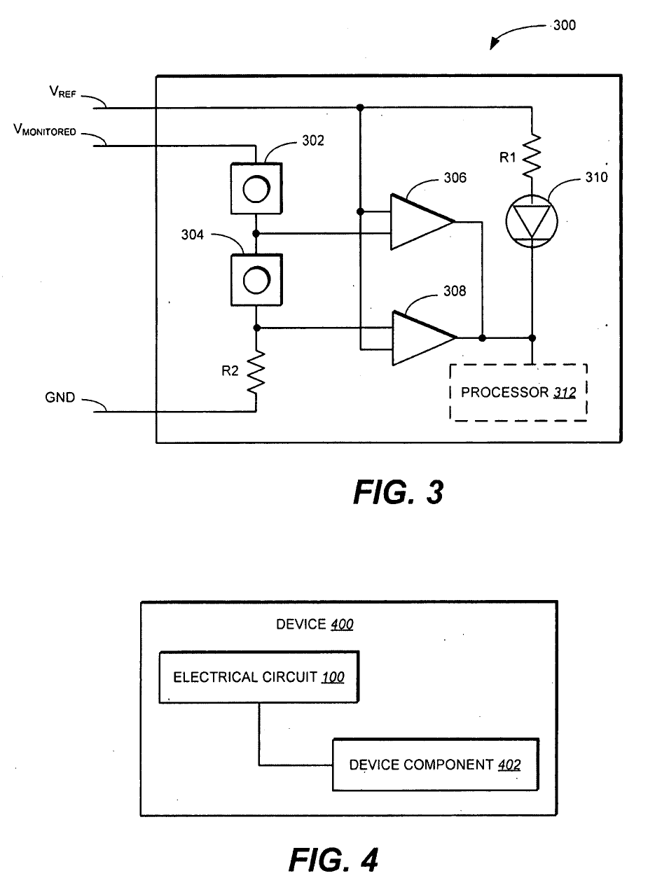

FIG. 3 illustrates a schematic diagram of an overvoltage sensor 300 including an indicator circuit in accordance with one implementation. The overvoltage sensor 300 includes potentiometers 302, 304, comparators 306, 308, resistors R1, R2, and a light-emitting diode (LED) 310. The potentiometer 302 is connected to the voltage to be monitored (V_{MONITORED}), the potentiometer 304, and an (invert) terminal of the comparator 306. The potentiometer 304 is further connected to the resistor R2, and a (non-invert) terminal of the comparator 308. The resistor R2 is also connected to ground (GND). A (non-invert) terminal of the compressor 306 is connected to the reference voltage (V_{REF}), and an output of the comparator 306 is connected to an output of the comparator 308 and the light-emitting diode (LED) 310. An (inverting) terminal of the comparator 308 is also connected to the reference voltage (V_{REF}). In addition, the resistor R2 is connected to the reference voltage (V_{REF}) and the light-emitting diode (LED) 310.

In one implementation, the voltage to be monitored (V_{MONITORED}), the reference voltage (V_{REF}), and ground (GND) are received from a jumper associated with an electrical circuit, as discussed above. In one implementation, the potentiometers 302, 304 are each adjustable by a user so that the user can set a threshold voltage at which the light-emitting diode (LED) 310 will illuminate. In one implementation, the user is provided with instructions that indicate pre-determined potentiometer settings that correspond to respective threshold voltages. The overvoltage sensor 300 can optionally include a processor 312 for generating control signals (as discussed above) responsive to an overvoltage of the voltage (V_{MONITORED}).

The overvoltage sensors 102, 300 discussed above can be packaged in a relatively small housing (e.g., having dimensions of 5 mm (W), 20 mm (L), 10 mm (H)). In general, the housing can have a customized shape suitable for particular applications.

FIG. 4 illustrates a device 400 including the electrical circuit 100 in accordance with one implementation. The device 400 can be any device including an electrical circuit. For example, the device 400 can be a computer system, portable hand-held device (including cellular phone, personal digital assistant (PDA), music listening device, digital camera, and the like), television, computer display, network device, printer, electronic toy, and so on. The device 400 further includes a device component 402 that receives a signal from the electrical circuit 100. The device component 402 can be, for example, a display screen of a computer display that receives video data from the electrical circuit 100. More generally, the device component 402 can be any component of a device operable to receive a signal.

Particular implementations can include one or more of the following advantages. In one implementation, a portable overvoltage sensor is provided that can easily be attached to an electrical circuit during manufacturing, and upon completion of manufacturing processes (or at an earlier point in time during the manufacturing processes) the same overvoltage sensor can be removed from the electrical circuit, and be attached to another electrical circuit. Accordingly, a relatively few number of portable overvoltage sensors can be used to sense overvoltage in a large number of electrical circuits. Also, rather than having a designed implement a complete overvoltage sensor within an electrical circuit (which can be quite costly for mass produced devices), in one implementation, a designed need only implement a jumper (or connector) to the electrical circuit to which the overvoltage sensor can be connected. In addition, in one implementation, an overvoltage sensor is provided that includes a light-emitting diode (LED) as an indicator of an overvoltage situation, such an LED indicator consumes low power and is easily noticeable by a user (e.g., a technician). Further, in one implementation, an overvoltage sensor is provided that can be tuned by a user to detect varying levels of overvoltages.

Various implementations for sensing overvoltage of an electrical circuit have been described. Nevertheless, one or ordinary skill in the art will readily recognize that there that various modifications may be made to the implementations, and any variation would be within the scope of the present invention. For example, though the method steps discussed above are described in connection with a manufacturing environment, the portable overvoltage sensors can be used to sense overvoltage in electrical circuit in other applications as well. Accordingly, many modifications may be made without departing from the scope of the following claims.

1. An overvoltage sensor operable to sense overvoltage in an electrical circuit, the overvoltage sensor comprising:
a first connector operable to be connected to a second connector of a provided electrical circuit, the second connector including a first lead connected to a first voltage in the provided electrical circuit; and
an indicator circuit coupled to the first connector, the indicator circuit to sense overvoltage of the first voltage responsive to the first connector being connected to the second connector, wherein the overvoltage sensor is portable in that the overvoltage sensor is attachable among a plurality of different provided electrical circuits.

2. (canceled)

3. The overvoltage sensor of claim 2, wherein the first connector is fixedly attached to the overvoltage sensor.

4. The overvoltage sensor of claim 2, wherein the first connector is attached to the overvoltage sensor through a wire having a pre-determined length.

5. The overvoltage sensor of claim 1, wherein the indicator circuit is operable to provide one or more of a visual indication, an audible indication, or a tactile indication responsive to sensing overvoltage of the first voltage in the provided electrical circuit.

6. The overvoltage sensor of claim 5, wherein the indicator circuit comprises a light-emitting diode (LED) operable to emit a light responsive to the indicator circuit sensing overvoltage of the first voltage in the provided electrical circuit.

7. The overvoltage sensor of claim 6, further comprising a processor to generate a control signal responsive to the indicator circuit sensing overvoltage of the first voltage in the provided electrical circuit.

8. The overvoltage sensor of claim 7, wherein:
the overvoltage sensor is connected to the provided electrical circuit in a manufacturing environment; and
the control signal halts operation of a manufacturing apparatus in the manufacturing environment.

9. The overvoltage sensor of claim 7, further comprising a transceiver operable to transmit a signal to a computer system responsive to the indicator circuit sensing overvoltage of the first voltage in the provided electrical circuit.

10. The overvoltage sensor of claim 1, wherein the second connector of the provided electrical circuit further includes,
a second lead connected to a reference voltage in the provided electrical circuit; and
a third lead connected to a ground in the provided electrical circuit,
wherein the indicator circuit is activated via the reference voltage and ground responsive to the first connector being connected to the second connector.

11. The overvoltage sensor of claim 1, wherein the indicator circuit comprises a potentiometer that is adjustable by a user, the potentiometer to set a threshold voltage at which the indicator circuit will indicate an overvoltage for the first voltage in the provided electrical circuit.

12. A method for sensing overvoltage in a plurality of electrical circuits in a manufacturing environment using a portable overvoltage sensor, each electrical circuit including a connector, the method comprising:
connecting the portable overvoltage sensor to a connector of a first electrical circuit of the plurality of electrical circuits;
passing the first electrical circuit having the portable overvoltage sensor connected thereto through a manufacturing process, the portable overvoltage sensor to sense overvoltage of a first voltage in the first electrical circuit during the manufacturing process; and
disconnecting the portable overvoltage sensor from the connector of the first electrical circuit responsive to completion of the manufacturing process.

13. The method of claim 12, further comprising:
connecting the portable overvoltage sensor to a connector of a second electrical circuit of the plurality of electrical circuits;
passing the second electrical circuit having the portable overvoltage sensor connected thereto through the manufacturing process, the portable overvoltage sensor to sense overvoltage of a first voltage in the second electrical circuit during the manufacturing process; and
disconnecting the portable overvoltage sensor from the connector of the second electrical circuit responsive to completion of the manufacturing process.

14. The method of claim 12, wherein the manufacturing process comprises one or more intermediate production processes for a device incorporating the first electrical circuit.

15. The method of claim 14, wherein the device is one of a computer system, portable hand-held device, television, computer display, network device, printer, or electronic toy.

16. The method of claim 12, wherein the portable overvoltage sensor includes an indicator to indicate overvoltage of the first voltage responsive to the overvoltage sensor being connected to the connector of the first electrical circuit.

17. The method of claim 16, wherein the indicator is operable to provide one or more of a visual indication, an audible indication, or a tactile indication responsive to the overvoltage sensor sensing overvoltage of the first voltage in the first electrical circuit.

18. The method of claim 17, wherein the indicator is a light-emitting diode (LED) operable to emit a light responsive to the overvoltage sensor sensing overvoltage of the first voltage in the first electrical circuit.

19. The method of claim 12, further comprising generating a control signal through a processor of the overvoltage sensor responsive to the overvoltage sensor sensing overvoltage of the first voltage in the first electrical circuit.

20. The method of claim 19, further comprising transmitting the control signal wirelessly to a computer system, the computer to alert a user of the overvoltage of the first voltage in the first electrical circuit.
